(19) United States
(12) Patent Application Publication
(10) Pub. No.: US 2025/0335314 A1
(43) Pub. Date: Oct. 30, 2025

(54) FAST, REVERSIBLE ROLLBACK AT SHARE LEVEL IN VIRTUALIZED FILE SERVER

(71) Applicant: Nutanix, Inc., San Jose, CA (US)

(72) Inventors: Abhinav Radheshyam Tiwari, Nagpur (IN); Jitendra Patidar, Pune (IN); Khushboo Kumari, Aurangabad (IN)

(21) Appl. No.: 18/756,809

(22) Filed: Jun. 27, 2024

(30) Foreign Application Priority Data
Apr. 24, 2024 (IN) 202441032372

(51) Int. Cl. G06F 11/14

(52) U.S. Cl. CPC G06F 11/1469; G06F 11/1451; G06F 11/1464

(57) ABSTRACT

A server-side restore technique enables restoring of files/folders of a distributed share directly on a file server executing on a node by a file server administrator using self-service restore (SSR) snapshots in accordance with an atomic 2-phase restore-commit transaction. The technique involves share-level restore wherein the entire share state transitions to a previous state of a snapshot, i.e., the granularity of the restore is at the share level (not the file level) for the technique (whereas file level restore granularity is typically used for the client-side restore). The technique is directed to server-side share level restore that allows an “undo” (i.e., rollback) of a previous restore operation into a live snapshot that has become corrupted by a subsequent rollback to a last known good (LKG) snapshot that is uncorrupted. An administration interface may be used to trigger the server-side restore technique for the distributed share.

### CROSS-REFERENCE TO RELATED APPLICATION

The present application claims the benefit of India Provisional Patent Application Ser. No. 20/244,1032372, which was filed on Apr. 24, 2024, by Abhinav Radheshyam Tiwari et al. for FAST, REVERSIBLE ROLLBACK AT SHARE LEVEL IN VIRTUALIZED FILE SERVER, which is hereby incorporated by reference.

### BACKGROUND

### Technical Field

The present disclosure relates to logical file system constructs, such as distributed shares, and, more specifically, to restoration of a distributed share of a file server in a client-server data protection environment.

### Background Information

A storage system may be configured as a file server that provides storage and management of datasets, such as files and/or directories/folders, which are usually served as a shared resource to user applications (clients) via various well-known data access (e.g., file system) protocols, such as network file system (NFS) and server message block (SMB). The file server may be further configured to operate according to a client/server model of information delivery to thereby allow many client systems (clients) to access the shared resource, e.g., a distributed share, stored on the file server.

Restoration of a distributed share may arise because of corruption at the share level, e.g., due to intentional/ransomware or unintentional/human error data state changes that require fixing (restoring) of file/folders of the share. Typically, restoration of the distributed share is orchestrated by the client in accordance with a client-side restore that involves operations on the file server. Since the data resides on the file server, the client-side restore may occur file-by-file or folder-by-folder to restore the share, which requires a round trip time (RTT) of operation latency over a network connection as well as data for the restoration flowing between client and server. Further such restore operations may not be practical across distributed shares or groups of shares since reversibility of restoration for all the shares is needed in case of failure of any one share to be restored. As such, a server-side restore/rollback share-based operation is desirable to avoid needless client-server interaction, data transfer and ensure synchronized recovery across distributed shares.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a block diagram of a controller virtual machine of the virtualization architecture;

FIG. 4 is a block diagram of metadata structures used to map virtual disks of the virtualization architecture;

FIGS. 5A-5C are block diagrams of an exemplary mechanism used to create a snapshot of a virtual disk;

FIG. 6 is a block diagram of a virtualized cluster environment implementing a File Server (FS) configured to provide a Files service;

FIG. 7 is a block diagram illustrating distribution of a high-level construct embodied as a distributed share across the FS;

FIG. 8 is a block diagram illustrating a snapshot chain of self-service restore (SSR) snapshots;

FIG. 9 is a block diagram illustrating renaming of SSR snapshots of original filesystem datasets;

FIG. 10 is a block diagram illustrating creation of SSR snapshots of a cloned filesystem dataset by cloning a last know good (LKG) snapshot; and

FIG. 11 is a block diagram illustrating promotion of the cloned filesystem dataset.

### OVERVIEW

The embodiments described herein are directed to a server-side restore technique that enables restoring of content (e.g., files/folders) of a distributed share directly (without client involvement) on a file server executing on a node by a file server administrator using self-service restore (SSR) snapshots in accordance with an atomic 2-phase restore-commit transaction. Illustratively, the server-side restore technique involves share-level restore wherein the entire share state transitions to a previous state of a snapshot, i.e., the granularity of the restore is at the share level (not the file level) for the server-side restore technique (whereas file level restore granularity is typically used for the client-side restore). The technique described herein is directed to server-side share level restore that allows an “undo” (i.e., rollback) of a previous restore operation into a live snapshot that has become corrupted by a subsequent rollback to a last known good (LKG) snapshot that is uncorrupted. An administration interface (e.g., out-of-band to a NAS protocol used to serve the share) may be used to trigger the server-side restore technique for the distributed share.

### DESCRIPTION

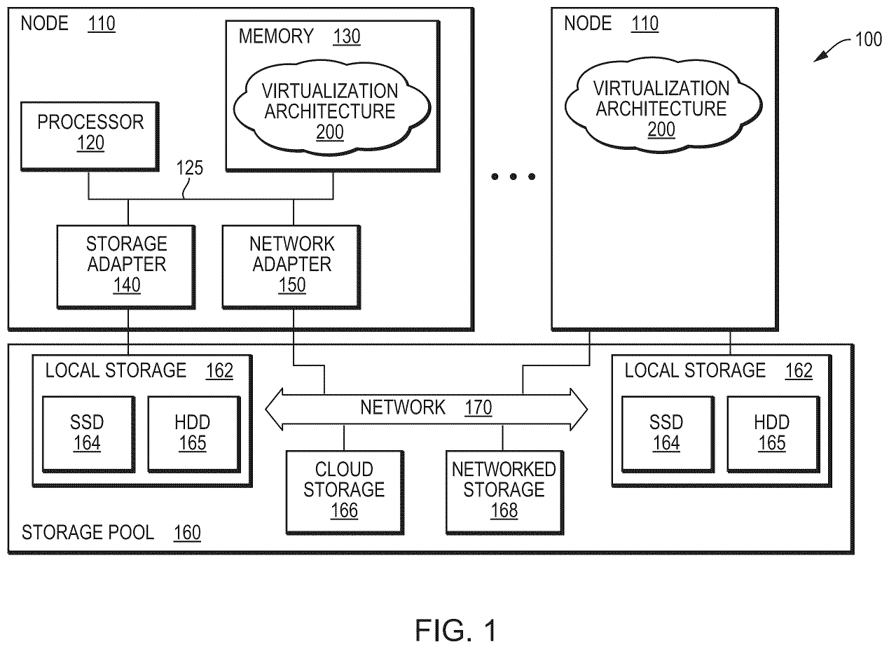

FIG. 1 is a block diagram of a plurality of nodes 110 interconnected as a logical or physical grouping such as, e.g., a cluster 100, and configured to provide compute and storage services for information, i.e., data and metadata, stored on storage devices of a virtualization environment. Each node 110 is illustratively embodied as a physical computer having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over a network, which is illustratively an Ethernet local area network (LAN) 170. The network adapter 150 may thus be embodied as a network interface card having the mechanical, electrical and signaling circuitry needed to connect the node 110 to the LAN. In an embodiment, one or more intermediate stations (e.g., a network switch, router, or virtual private network gateway) may interconnect the LAN with network segments organized as a wide area network (WAN) to enable communication between the nodes of cluster 100 and remote nodes of a remote cluster over the LAN and WAN (hereinafter “network”) as described further herein. The multiple tiers of SOCS include storage that is accessible through the network, such as cloud storage 166 and/or networked storage 168, as well as the local storage 162 within or directly attached to the node 110 and managed as part of the storage pool 160 of storage items, such as files and/or logical units (LUNs). The cloud and/or networked storage may be embodied as network attached storage (NAS) or storage area network (SAN) and include combinations of storage devices (e.g., SSDs and/or HDDs) from the storage pool 160. Communication over the network may be affected by exchanging discrete frames or packets of data according to protocols, such as the Transmission Control Protocol/Internet Protocol (TCP/IP) and User Datagram Protocol (UDP), as well as protocols for authentication, such as the OpenID Connect (OIDC) protocol, while other protocols for secure transmission, such as the HyperText Transfer Protocol Secure (HTTPS) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include processes that may spawn and control a plurality of threads (i.e., the process creates and controls multiple threads), wherein the code, processes, threads, and programs may be embodied as logic, components, and/or modules consisting of hardware, software, firmware, or combinations thereof.

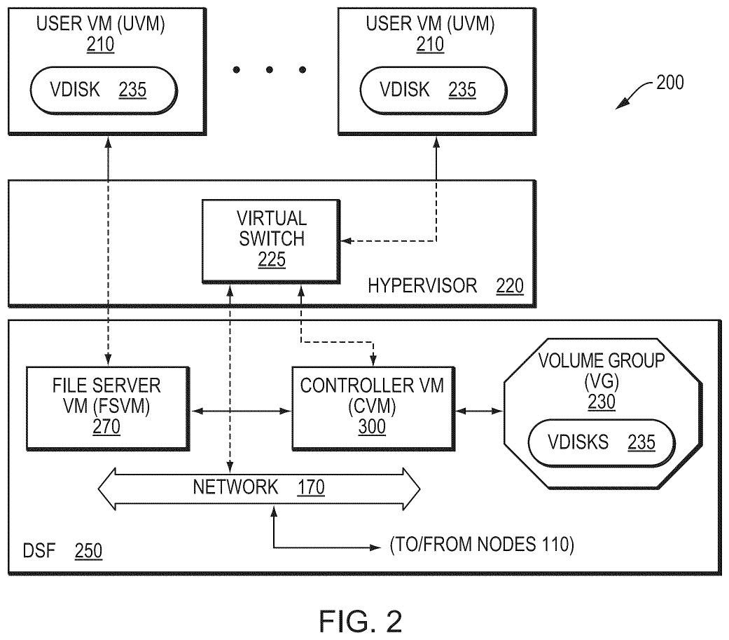

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. That is, the UVMs 210 may run one or more applications that operate as “clients” with respect to other components and resources within virtualization environment providing services to the clients. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 300, which functions as a virtual controller for SOCS. The CVMs 300 on the nodes 110 of the cluster 100 interact and cooperate to form a distributed data processing system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyper-convergence architecture wherein the nodes provide both storage and computational resources available cluster wide.

A file server virtual machine (FSVM) 270 is a software component that provides file services to the UVMs 210 including storing, retrieving, and processing I/O data access operations requested by the UVMs 210 and directed to information stored on the DSF 250. To that end, the FSVM 270 implements a file system (e.g., a Unix-like inode based file system) that is virtualized to logically organize the information as a hierarchical structure (i.e., a file system hierarchy) of named directories and files on, e.g., the storage devices (“on-disk”). The FSVM 270 includes a protocol stack having network file system (NFS) and/or Common Internet File system (CIFS) (and/or, in some embodiments, server message block, SMB) processes that cooperate with the virtualized file system to provide a Files service, as described further herein. The information (data) stored on the DFS may be represented as a set of storage items, such as files organized in a hierarchical structure of folders (directories), which can contain files and other folders, as well as shares and exports. Illustratively, the shares (CIFS) and exports (NFS) encapsulate file directories, which may also contain files and folders.

In an embodiment, the FSVM 270 may have two IP (network) addresses: an external IP (service) address and an internal IP address. The external IP service address may be used by clients, such as UVM 210, to connect to the FSVM 270. The internal IP address may be used for iSCSI communication with CVM 300, e.g., between FSVM 270 and CVM 300. For example, FSVM 270 may communicate with storage resources provided by CVM 300 to manage (e.g., store and retrieve) files, folders, shares, exports, or other storage items stored on storage pool 160. The FSVM 270 may also store and retrieve block-level data, including block-level representations of the storage items, on the storage pool 160.

The client software (e.g., applications) running in the UVMs 210 may access the DSF 250 using filesystem protocols, such as the NFS protocol, the SMB protocol, the common internet file system (CIFS) protocol, and the internet small computer system interface (iSCSI) protocol. Operations on these filesystem protocols are interposed at the hypervisor 220 and forwarded to the FSVM 270, which cooperates with the CVM 300 to perform the operations on data stored on local storage 162 of the storage pool 160. The CVM 300 may export one or more iSCSI, CIFS, or NFS targets organized from the storage items in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, SMB, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the vdisks 235 may be organized into one or more volume groups (VGs), wherein each VG 230 may include a group of one or more storage devices that are present in local storage 162 associated (e.g., by iSCSI communication) with the CVM 300. The one or more VGs 230 may store an on-disk structure of the virtualized file system of the FSVM 270 and communicate with the virtualized file system using a storage protocol (e.g., iSCSI). The “on-disk” file system may be implemented as a set of data structures, e.g., disk blocks, configured to store information, including the actual data for files of the file system. A directory may be implemented as a specially formatted file in which information about other files and directories are stored.

In an embodiment, the virtual switch 225 may be employed to enable I/O accesses from a UVM 210 to a storage device via a CVM 300 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 260. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 300 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 300 within the same node as the UVM 210, then the IP-based storage protocol request is internally forwarded within the node to the CVM. The CVM 300 is configured and structured to properly interpret and process that request. Notably the IP-based storage protocol request packets may remain in the node 110 when the communication—the request and the response—begins and ends within the hypervisor 220. In other embodiments, the IP-based storage protocol request may be routed by the virtual switch 225 to a CVM 300 on another node of the same or different cluster for processing. Specifically, the IP-based storage protocol request may be forwarded by the virtual switch 225 to an intermediate station (not shown) for transmission over the network (e.g., WAN) to the other node. The virtual switch 225 within the hypervisor 220 on the other node then forwards the request to the CVM 300 on that node for further processing.

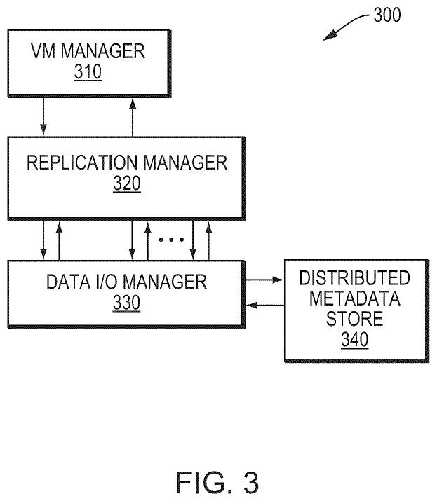

FIG. 3 is a block diagram of the controller virtual machine (CVM) 300 of the virtualization architecture 200. In one or more embodiments, the CVM 300 runs an operating system (e.g., the Acropolis operating system) that is a variant of the Linux® operating system, although other operating systems may also be used in accordance with the embodiments described herein. The CVM 300 functions as a distributed storage controller to manage storage and I/O activities within DSF 250 of the cluster 100. Illustratively, the CVM 300 runs as a virtual machine above the hypervisor 220 on each node and cooperates with other CVMs in the cluster to form the distributed system that manages the storage resources of the cluster, including the local storage 162, the networked storage 168, and the cloud storage 166. Since the CVMs run as virtual machines above the hypervisors and, thus, can be used in conjunction with any hypervisor from any virtualization vendor, the virtualization architecture 200 can be used and implemented within any virtual machine architecture, allowing the CVM to be hypervisor agnostic. The CVM 300 may therefore be used in a variety of different operating environments due to the broad interoperability of the industry standard IP-based storage protocols (e.g., iSCSI, CIFS, and NFS) supported by the CVM.

Illustratively, the CVM 300 includes a plurality of processes embodied as services of a storage stack running in a user space of the operating system of the CVM to provide storage and I/O management services within DSF 250. The processes include a virtual machine (VM) manager 310 configured to manage creation, deletion, addition and removal of virtual machines (such as UVMs 210) on a node 110 of the cluster 100. For example, if a UVM fails or crashes, the VM manager 310 may spawn another UVM 210 on the node. A replication manager 320 is configured to provide replication capabilities of DSF 250. Such capabilities include migration of virtual machines and storage containers, as well as scheduling of snapshots. A data I/O manager 330 is responsible for all data management and I/O operations in DSF 250 and provides a main interface to/from the hypervisor 220, e.g., via the IP-based storage protocols. Illustratively, the data I/O manager 330 presents a vdisk 235 to the UVM 210 in order to service I/O access requests by the UVM to the DFS. In an embodiment, the data I/O manager 330 may interact with a replicator process of the FSVM 270 to replicate full and periodic snapshots, as described herein. A distributed metadata store 340 stores and manages all metadata in the node/cluster, including metadata structures that store metadata used to locate (map) the actual content of vdisks on the storage devices of the cluster.

Operationally, a client (e.g., UVM 210) may send an I/O request (e.g., a read or write operation) to the FSVM 270 (e.g., via the hypervisor 220) and the FSVM 270 may perform the operation specified by the request, e.g., in accordance with a client/server model of information delivery. The FSVM 270 may present a virtualized file system to the UVM 210 as a namespace of mappable shared drives or mountable network filesystems of files and directories. The namespace of the virtualized filesystem may be implemented using storage devices of the storage pool 160 onto which the shared drives or network filesystems, files, and folders, exports, or portions thereof may be distributed as determined by the FSVM 270. The FSVM 270 may present the storage capacity of the storage devices as an efficient, highly available, and scalable namespace in which the UVMs 210 may create and access shares, exports, files, and/or folders. As an example, a share or export may be presented to a UVM 210 as one or more discrete vdisks 235, but each vdisk may correspond to any part of one or more virtual or physical disks (storage devices) within storage pool 160. The FSVM 270 may access the storage pool 160 via the CVM 300. The CVM 300 may cooperate with the FSVM 270 to perform I/O requests to the storage pool 160 using local storage 162 within the same node 110, by connecting via the network 170 to cloud storage 166 or networked storage 168, or by connecting via the network 170 to local storage 162 within another node 110 of the cluster (e.g., by connecting to another CVM 300).

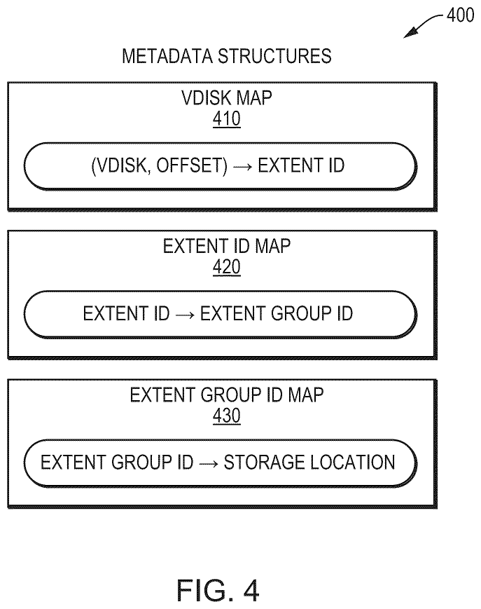

FIG. 4 is a block diagram of metadata structures 400 used to map virtual disks of the virtualization architecture. Each vdisk 235 corresponds to a virtual address space for storage exposed as a disk to the UVMs 210. Illustratively, the address space is divided into equal sized units called virtual blocks (vblocks). A vblock is a chunk of pre-determined storage, e.g., 1 MB, corresponding to a virtual address space of the vdisk that is used as the basis of metadata block map structures described herein. The data in each vblock is physically stored on a storage device in units called extents. Extents may be written/read/modified on a sub-extent basis (called a slice) for granularity and efficiency, A plurality of extents may be grouped together in a unit called an extent group. Each extent and extent group may be assigned a unique identifier (ID), referred to as an extent ID and extent group ID, respectively. An extent group is a unit of physical allocation that is stored as a file on the storage devices.

Illustratively, a first metadata structure embodied as a vdisk map 410 is used to logically map the vdisk address space for stored extents. Given a specified vdisk and offset, the logical vdisk map 410 may be used to identify a corresponding extent (represented by extent ID). A second metadata structure embodied as an extent ID map 420 is used to logically map an extent to an extent group. Given a specified extent ID, the logical extent ID map 420 may be used to identify a corresponding extent group containing the extent. A third metadata structure embodied as an extent group ID map 430 is used to map a specific physical storage location for the extent group. Given a specified extent group ID, the physical extent group ID map 430 may be used to identify information corresponding to the physical location of the extent group on the storage devices such as, for example, (1) an identifier of a storage device that stores the extent group, (2) a list of extent IDs corresponding to extents in that extent group, and (3) information about the extents, such as reference counts, checksums, and offset locations.

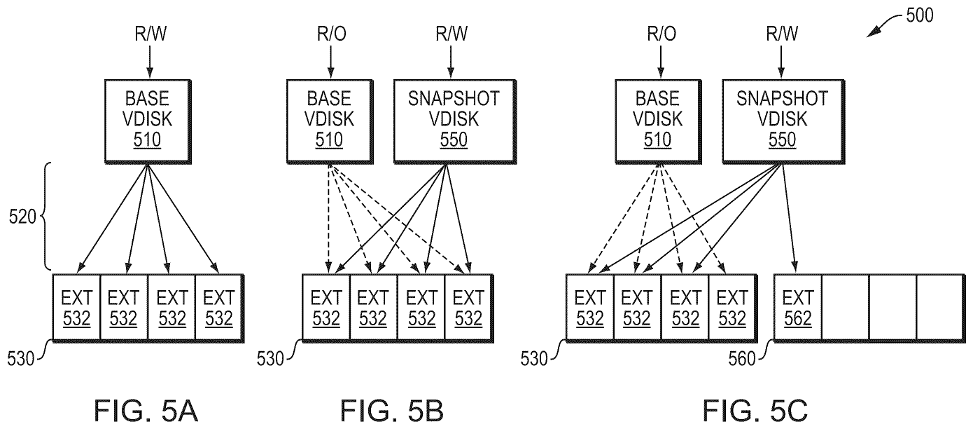

In an embodiment, CVM 300 and DSF 250 cooperate to provide support for snapshots, which are point-in-time copies of storage objects, such as files, LUNs and/or vdisks. FIGS. 5A-5C are block diagrams of an exemplary mechanism 500 used to create a snapshot of a virtual disk. Illustratively, the snapshot may be created by leveraging an efficient low overhead snapshot mechanism, such as the redirect-on-write algorithm. As shown in FIG. 5A, the vdisk (base vdisk 510) is originally marked read/write (R/W) and has an associated block map 520, i.e., a metadata mapping with pointers that reference (point to) the extents 532 of an extent group 530 storing data of the vdisk on storage devices of DSF 250. Associating a block map with a vdisk may, in some cases, obviate traversal of a snapshot chain, as well as corresponding overhead (e.g., read latency) and performance impact.

To create the snapshot (FIG. 5B), another vdisk (snapshot vdisk 550) is created by sharing the block map 520 with the base vdisk 510. This feature of the low overhead snapshot mechanism enables creation of the snapshot vdisk 550 without the need to immediately copy the contents of the base vdisk 510. Notably, the snapshot mechanism uses redirect-on-write such that, from the UVM perspective, I/O accesses to the vdisk are redirected to the snapshot vdisk 550 which now becomes the (live) vdisk and the base vdisk 510 becomes the point-in-time copy, i.e., an “immutable snapshot,” of the vdisk data. The base vdisk 510 is then marked immutable, e.g., read-only (R/O), and the snapshot vdisk 550 is marked as mutable, e.g., read/write (R/W), to accommodate new writes and copying of data from the base vdisk to the snapshot vdisk. In an embodiment, the contents of the snapshot vdisk 550 may be populated at a later time using, e.g., a lazy copy procedure in which the contents of the base vdisk 510 are copied to the snapshot vdisk 550 over time. The lazy copy procedure may configure DSF 250 to wait until a period of light resource usage or activity to perform copying of existing data in the base vdisk. Note that each vdisk includes its own metadata structures 400 used to identify and locate extents owned by the vdisk.

Another procedure that may be employed to populate the snapshot vdisk 550 waits until there is a request to write (i.e., modify) data in the snapshot vdisk 550. Depending upon the type of requested write operation performed on the data, there may or may not be a need to perform copying of the existing data from the base vdisk 510 to the snapshot vdisk 550. For example, the requested write operation may completely or substantially overwrite the contents of a vblock in the snapshot vdisk 550 with new data. Since the existing data of the corresponding vblock in the base vdisk 510 will be overwritten, no copying of that existing data is needed and the new data may be written to the snapshot vdisk at an unoccupied location on the DSF storage (FIG. 5C). Here, the block map 520 of the snapshot vdisk 550 directly references a new extent 562 of a new extent group 560 storing the new data on storage devices of DSF 250. However, if the requested write operation only overwrites a small portion of the existing data in the base vdisk 510, the contents of the corresponding vblock in the base vdisk may be copied to the snapshot vdisk 550 and the new data of the write operation may be written to the snapshot vdisk to modify that portion of the copied vblock. A combination of these procedures may be employed to populate the data content of the snapshot vdisk.

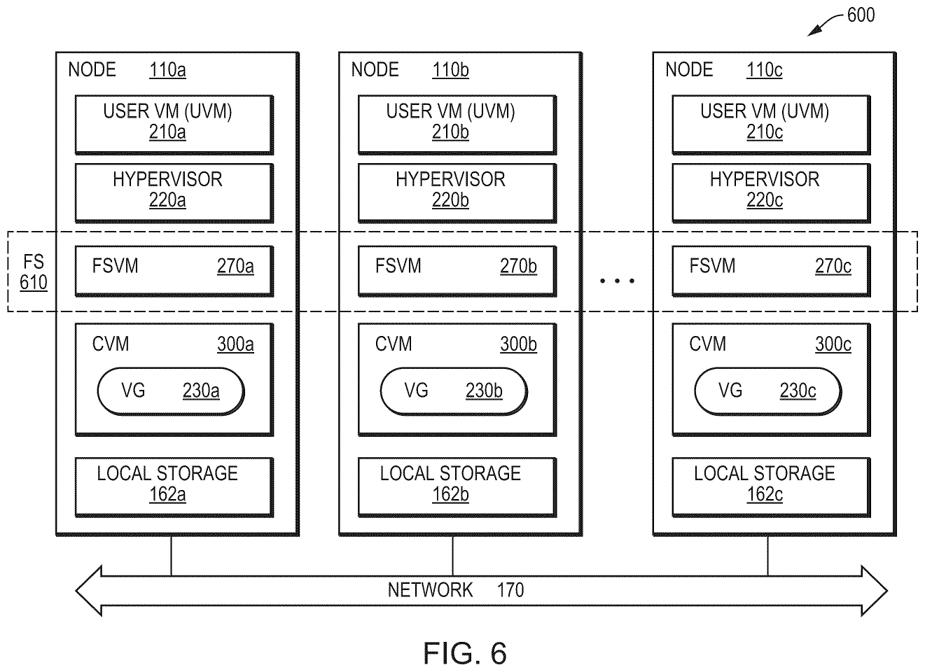

In an embodiment, the Files service provided by the virtualized file system of the FSVM 270 implements a software-defined, scale-out architecture that provides file services to clients through, e.g., the CIFS and NFS filesystem protocols provided by the protocol stack of FSVM 270. The architecture combines one or more FSVMs 270 into a logical file server instance, referred to as a File Server, within a virtualized cluster environment. FIG. 6 is a block diagram of a virtualized cluster environment 600 implementing a File Server (FS) 610 configured to provide the Files service. As noted, the FS 610 provides file services to user VMs 210, which services include storing and retrieving data persistently, reliably, and efficiently. In one or more embodiment, the FS 610 may include a set of FSVMs 270 (e.g., three FSVMs 270a-c) that execute on host machines (e.g., nodes 110a-c) and process storage item access operations requested by user VMs 210a-c executing on the nodes 210a-c. Illustratively, one FSVM 270 is stored (hosted) on each node 110 of the computing node cluster 100, although multiple FSs 610 may be created on a single cluster 100. The FSVMs 270a-c may communicate with storage controllers provided by CVMs 300a-c executing on the nodes 210a-c to store and retrieve files, folders, shares, exports, or other storage items on local storage 162a-c associated with, e.g., local to, the nodes 201a-c. One or more VGs 230a-c may be created for the FSVMs 270a-c, wherein each VG 230 may include a group of one or more available storage devices present in local storage 162 associated with (e.g., by iSCSI communication) the CVM 300. As noted, the VG 230 stores an on-disk structure of the virtualized file system to provide stable storage for persistent states and events. During a service outage, the states, storage, and events of a VG 230 may failover to another FSVM 270.

### Shares

In an embodiment, the Files service provided by the virtualized file system of the FSVM 270 includes two types of shares or exports (hereinafter “shares”): a distributed share and a standard share. A distributed (“home”) share load balances access requests to user data in a FS 610 by distributing logical constructs, such as root or top-level file directories (TLDs), across the FSVMs 270 of the FS 610, e.g., to improve performance of the access requests and to provide increased scalability of client connections. In this manner, the FSVMs effectively distribute the load for servicing connections and access requests. Illustratively, distributed shares are available on FS deployments having three or more FSVMs 270. In contrast, all of the data of a standard (“general purpose”) share is directed to a single FSVM, which serves all connections to clients. That is, all of the TLDs of a standard share are managed by a single FSVM 270.

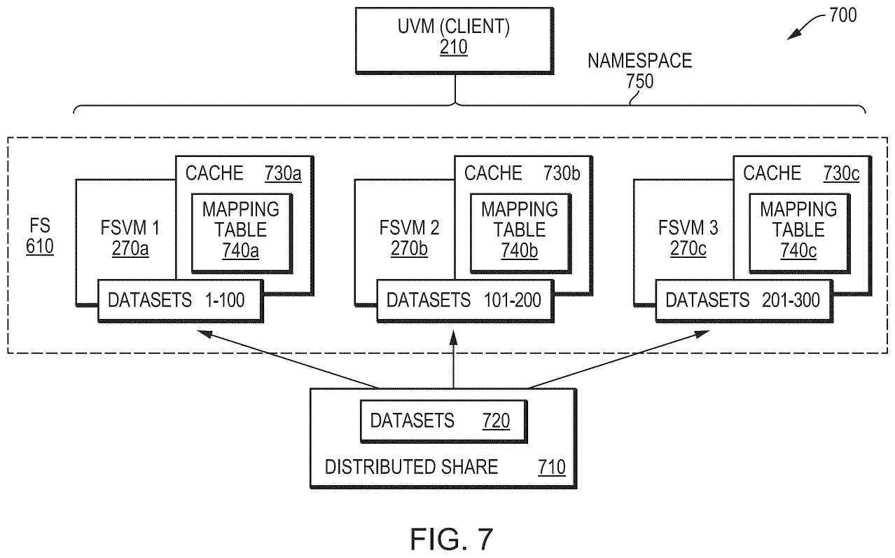

FIG. 7 is a block diagram illustrating distribution of a high-level construct embodied as a distributed share across the FS. Assume the distributed share 710 includes a plurality of filesystem datasets (e.g., files and/or folders, the latter of which are embodied as TLDs) sharded (distributed) across FSVMs (and, more specifically, VGs of the FSVMs) executing on nodes of the cluster. For instance, assume that three hundred (300) TLDs (hereinafter “datasets 720”) are distributed and managed among three (3) FSVMs1-3 (270a-c) of FS1 610, e.g., FSVM1 manages datasets1-100, FSVM2 manages datasets 101-200, and FSVM3 manages datasets201-300. In one or more embodiments, FSVMs 1-3 cooperate to provide a single namespace 750 of the datasets for the distributed share 710 to UVM 210 (client), whereas each FSVM1-3 is responsible for managing a portion (e.g., 100 datasets) of the single namespace 750 (e.g., 300 datasets). The client may send a request to connect to a network (service) address of any FSVM1-3 of the FS 610 to access one or more datasets 720 of the distributed share 710.

In an embodiment, a portion of memory 130 of each node 110 may be organized as a cache 730a-c that is distributed among the FSVMs 270 of the FS 610 and configured to maintain one or more mapping data structures (e.g., mapping tables 740) specifying locations (i.e., the FSVM) of each of the datasets 720 of the distributed share 710. That is, the mapping tables 740 associate nodes for FSVM1-3 with the datasets 720 to define a distributed service workload among the FSVMs (i.e., the nodes executing the FSVMs) for accessing the FS 610. If the client request to access a particular dataset (e.g., dataset 150) of the distributed share 720 is received at a FSVM (e.g., FSVM1) that is not responsible for managing the dataset, a redirect request is sent to the client informing the client that the dataset150 may be accessed from the FSVM responsible (according to the mapping) for servicing (and managing) the dataset (e.g., FSVM2) as determined, e.g., from the location mapping table 740. The client may then send the request to access the dataset 150 of the distributed share to FSVM2. Similarly, if a client connects to a particular FSVM (e.g., FSVM2) of FS 610 to access a dataset of a standard share managed by a different FSVM (e.g., FSVM1), FSVM2 sends a redirect request to the client informing the client that the dataset may be accessed from FSVM1. The client may then send the access request for the dataset to FSVM1. Notably, the mapping tables 740 may be updated (altered) according to changes in a workload pattern among the FSVMs to improve the load balance.

A self-service restore (SSR) policy is an intra-file server, share-level data protection policy for a distributed share 710. Snapshots for the distributed share 710 are periodically generated as defined by the SSR policy. The frequency of these SSR snapshots establishes a data loss time window or recovery point objective (RPO). A snapshot frequency (e.g., hourly, weekly, monthly) and retention count (e.g., number of snapshots to retain/maintain in a rolling fashion) as defined by the SSR policy enables recovery of one or more captured states of the distributed share. Note that backup snapshots, e.g., for backup or disaster recovery (DR), are treated differently than SSR snapshots. For example, SSR snapshots are completely managed by a FS 610 and, thus, are “internal” snapshots, whereas backup snapshots are managed by a backup service via application program interfaces (APIs) for the backup service. The SSR snapshots are used to recover corrupted shares of the FS 610, i.e., corrupted data of the shares may be recovered by the SSR snapshots. Note that the Windows operating system (OS) has a “Windows previous version” (WPV) service that may leverage internal (SSR) snapshots for recovery.

In an embodiment, SSR snapshots are exposed to NFS/SMB clients (e.g., client applications running in the UVMs 210 and accessing the DSF 250 using NFS/SMB protocols) over specified paths, wherein an example of a SSR snapshot path is:
<file server name/share-name/.snapshot/<snapshot-name>/snapshot content/

Restoration of a distributed share 710 may arise because of corruption at the share level (e.g., due to intentional/ransomware or unintentional/human error data state changes) that requires fixing (recovering or restoring) of datasets 720 (file/folders) of the share. In the event of corruption to a file or group of files of a distributed share 710, the specified path may be used by a NFS client to copy the content of the snapshot using a NFS restore service, whereas a SMB client may invoke the WPV service using the specified path. The SSR snapshots may be used to perform restore operations of certain files/folders for a given share where orchestration of the operation is triggered by an NFS/SMB client that connects to the FS 610.

For example, assume a file of a current, “live” distributed share 710 is corrupted and the client wants to restore the file back to a file version present in snapshot 3 (e.g., S2 according to the hierarchy of snapshots S1-4 below):

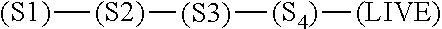

For NFS restore, the specified path for S2 <snapshot-name> may be accessed by the NFS client to copy the file content (data) from, e.g., the “snapshot” path (path A) to the “live share” path (path B). Essentially, such a client-side restore involves the following client orchestrated operations on the FS 610:
1. Read data from file server at path A; and
2. Write that data back to file server at path B (different path).

However, since the data resides on the FS 610, the client-side restore incurs file-by-file or folder-by-folder round trip time (RTT) of operation latency over a network connection as well as data for the restoration flowing between client and server. As such, a server-side (file server) restore that orchestrates the operations at the FS 610 and eliminates the RTT of associated operations orchestrated by the client, as well as any associated data transfer between the client and server, is beneficial. Note that the time incurred for the client-side restore is proportional to the number of files that need restoring and the average amount (size) of the data to restore/move, as well as the network RTT:

$$Time = ( \# files ) \times ( avg data size ) \times RTT latency .$$

The embodiments described herein are directed to a server-side restore technique that enables restoring of content (e.g., files/folders) of a distributed share directly (without client involvement) on a file server executing on a node by a file server administrator using self-service restore (SSR) snapshots in accordance with an atomic 2-phase restore-commit transaction to ensure completion. Illustratively, the server-side restore technique involves share-level restore wherein the entire share state transitions to a previous state of a snapshot, i.e., the granularity of the restore is at the share level (not the file level) for the server-side restore technique (whereas file level restore granularity is typically for the client-side restore). The technique described herein is directed to server-side share level restore that allows an “undo” (i.e., rollback) of a previous restore operation into a live snapshot that has become corrupted by a subsequent rollback to a last known good (LKG) snapshot that is uncorrupted. An administration interface (e.g., out-of-band to a NAS protocol used to server the share) may be used to trigger the server-side restore technique for the distributed share.

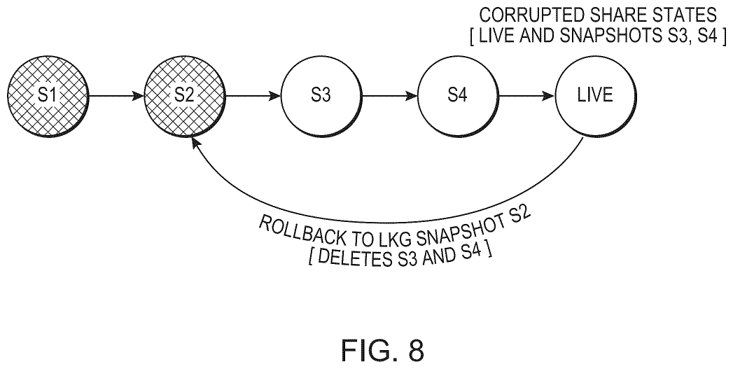

Typical solutions for share-restore are irreversible and tend to destroy the intermediate/intervening snapshots between the live data state and the LKG snapshot (S2) state (newer than the LKG snapshot S2, but older than the current live state), i.e., corruption in the live snapshot results in a rollback to snapshot S2 (LKG) which deletes/removes the intermediate/intervening snapshots S3 and S4. However, a failure of the restoration as a multi-step process may not be reversible when intervening data is lost. FIG. 8 is a block diagram illustrating a snapshot chain 800 of self-service restore (SSR) snapshots. As noted, snapshots are generated at periodic intervals defined by the SSR policy. The SSR snapshots may be represented as snapshot chain 800 of share states including snapshots S1-S4 up to the live snapshot (Live). Illustratively, the newest snapshot (Live) is based on a previous snapshot (S4), e.g., using copy-on-write to capture changes or deltas to the previous snapshot.

Upon detection of corruption in the data of a share, the server-side restore technique described herein allows rollback and restore of the share state to a LKG snapshot state, e.g., S2. To that end, the technique satisfies requirements such as performance, failure-safety, and reversibility. The technique provides fast performance by eliminating client-side time constraint (RTT) and leveraging filesystem (e.g., Zettabyte filesystem, such as OpenZFS) capability to change a pointer referencing a current (live snapshot) state of a share within a snapshot chain to a LKG (S2 snapshot) state of the share in accordance with a restore stage of the atomic transaction. As noted, the distributed share includes filesystem datasets (e.g., files/folders) sharded (distributed) across VGs and nodes of the cluster. The technique satisfies the failure-safety requirement by ensuring that a restore operation performed on the distributed share restores all of the sharded datasets across the VGs atomically, i.e., to ensure a fail-safe undo (reversible) operation in the event rollback fails, e.g., due to corruption of one of the sharded datasets. The reversibility requirement is directed to undo of any incorrect share restore operation, e.g., if a restore operation to S2 is not the correct LKG share state and S3 is the correct LKG state, the technique has the ability to undo the restore operation to S2 and correctly restore the LKG state to S3 because the commit stage of the atomic transaction has not completed.

In an embodiment, an administrator may determine files which will change in terms of creation/updates/deletion between the current live data state and the LKG snapshot data state. Particularly, tracking/listing of files to be deleted is beneficial since the administrator can evaluate the corruption on a file basis and take appropriate action such as a manual backup. Changed file tracking (CFT) for share-level restore may employ a similar CFT feature used for file-level backup. CFT can also be used for solving another problem that arises for shares with tiering enabled: the remote tiered data on an object store also needs to be corrected for consistency with the LKG snapshot data state being used for share-restore operation.

In an embodiment, the server-side restore technique performs a reversible “out-of-place” restore that guarantees the failure safety requirement through use of cloning for restoring to a LKG snapshot state and the ability to reverse the restoration by deleting the clone of a restored snapshot if the snapshot was, e.g., corrupted or incorrectly identified as the LKG snapshot. In contrast, a conventional “in-place” restore operation does not employ cloning but rather performs a restore operation directly to a previous snapshot of a snapshot chain. For example, the in-place restore operation may leverage a filesystem (e.g., OpenZFS) command that redirects a pointer to reference a previous snapshot of the chain “in place” which redirection, once invoked, cannot be undone.

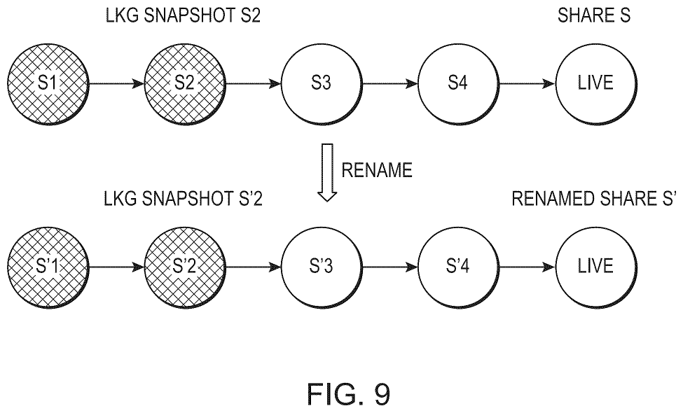

Specifically, the out-of-place restore feature of the technique involves a sequence of three (3) filesystem steps on the filesystem datasets of a logical distributed share, e.g., in a sequence: rename, clone, and promote (decouple and reverse dependency between the clone and file system datasets). FIG. 9 is a block diagram illustrating renaming of SSR snapshot of original filesystem datasets. Illustratively, original filesystem datasets are initially renamed from <original-share-ID> to <original-share-ID>.old, essentially to save a subsequent rename operation.

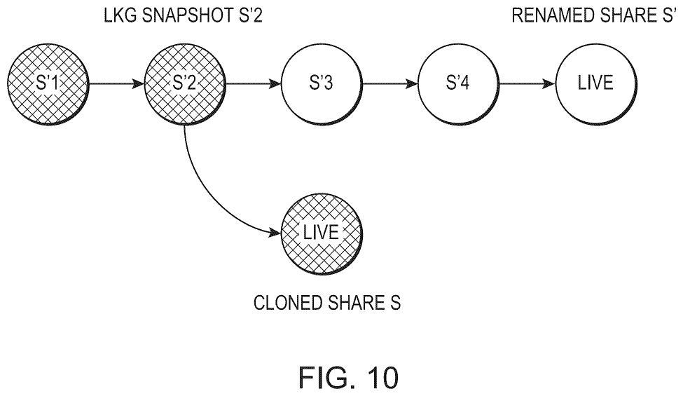

FIG. 10 is a block diagram illustrating creation of SSR snapshots of a filesystem dataset by cloning a last know good (LKG) snapshot. A new filesystem dataset <original-share-ID> is created by cloning the LKG snapshot “<original-share-ID>.old@<snapshot-name>.” Note that the original-renamed dataset S′ still exists. Performing the rename step prior to the cloning step avoids two rename steps if cloning was performed first. The new datasets are referenced to an original uncorrupted LKG data set for the share (and thus is where the “out-of-place” restore originates).

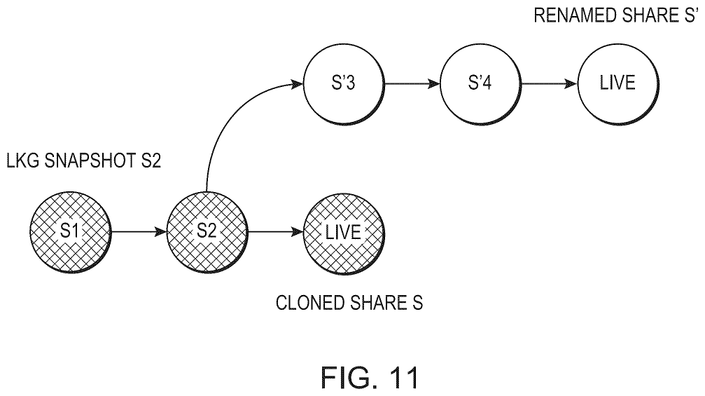

FIG. 11 is a block diagram illustrating promotion of the cloned filesystem dataset S that decouples and reverses dependency between the original filesystem and the clone. The cloned share Live is thereafter branched (forked) off at a branching point from renamed snapshot S2′ (LKG). The promoted cloned dataset inherits the older snapshots of the original-renamed datasets S′ before the branching point. Illustratively, some file systems, such as OpenZFS, support promotion of a clone that decouples and reverses dependency between the promoted clone and the original-renamed dataset such that the original-renamed dataset is dependent on the promoted clone, which inherits the snapshots of original-renamed dataset S′ (in effect, ownership of the data blocks is swapped between the datasets). In this manner, the original-renamed dataset can now be deleted as data in the promoted clone no longer depends on data in the original-renamed dataset. The promotion step also renames the older snapshots, e.g., from S′ to S. Initially, the cloned datasets have a parent-child dependency on the LKG snapshot and, thus, the original-renamed datasets cannot be deleted. As indicated above, the technique invokes the promote operation step to reverse the parent-child relationship so that the cloned datasets inherit the older snapshots including the LKG snapshot and permit the original renamed datasets to be deleted. Upon completion of the rename, clone and promote filesystem steps, the new cloned share datasets are exposed for an administrator to validate that the datasets (and paths) are as desired, e.g., correct and uncorrupted. Upon validation, the user commits the restore operations and may delete/destroy the original filesystem datasets.

Since the original file-system datasets are available at all points in the operation, any failure in-between the entire sequence of steps can be handled by reverting/undoing the partial sequence of steps already performed, i.e., reversing the renaming and by re-promoting the original dataset to effectively un-promote the clone. This ensures failure-safety in terms of share data consistency particularly for a distributed share since any file-system operation step is performed for all file-system datasets in a batch manner either consecutively or partially concurrently.

At this point, the original file-system datasets can be deleted which includes the newer snapshots relative to the LKG snapshot. However, the original filesystem datasets are not immediately destroyed; rather the operation is split in two (2) phases: restore and commit. Upon completion of the restore phase, the share-restore operation is successfully completed with the original uncorrupted share available for read-writes. After the restore phase, an administrator can deem the share restore operation as being correct or incorrect with respect to expected original uncorrupted data state. Once the share restore operation is deemed correct, the administrator may proceed to the commit phase to finally delete the original filesystem datasets. In other words, prior to the commit stage, the technique allows a user to undo the restore operation and revert (back) to a previous (original) state while maintaining all intervening snapshots so as to maintain RPO requirements. Another restore operation can then be performed and the datasets/paths validated prior to commit.

Advantageously, splitting the entire operation in two phases achieves two salient features of the technique: performance and reversibility. Pre-processing of the share features (e.g., tiering etc.) can be postponed to the commit phase, thereby improving performance by ensuring an upper bound on a reversion time being measured as the time taken by the first phase. If the operation fails (e.g., one or more operations across a group of datasets) or is deemed incorrect (perhaps due to incorrect or corrupt LKG snapshot) after the restore phase, the operation can be reversed (undone). Again, reversibility is achieved by virtue of availability of the original filesystem share datasets at the end of restore phase. Essentially, the technique allows for revert/undo of the entire sequence of steps performed in the restore phase. Once the revert/undo is complete, the entire share-restore operation can be re-started from the beginning with no penalty in terms of data loss.

Tiering at the share level involves moving infrequently used (cold) data to an archival storage class, such as an object store (e.g., S3) to reduce storage costs. States of the distributed share may include online and offline, wherein the online state has data locally available and present on the VGs, and the offline state has data moved to archival storage tiers of the object store. The offline state employs a stub (small file) having metadata that describes the data and its location (index) in the object store. Illustratively, share restore operates on offline data to completely restore the distributed share including its offline state by accessing the object store (using the stub and CFT) to manipulate files and ensure data consistency after the restore. Since it is undesirable for offline data restore of the distributed share that is stored on tiered storage of the object store to impact recovery time objective (RTO), determining which files/data are online vs offline (i.e., in archival storage) is desirable. In an embodiment, upon committing, the CFT operation is performed between the LKG (e.g., S2) and Live snapshots to determine which files of the online/offline states have changed.

Assume a file is moved from online to offline storage on the object store. The file is not tiered in the Live (current snapshot data) state but is tiered in snapshot S2. When recalling the file from the object store, a garbage collection (GC) tag that was placed on the file in the object store is removed that prevented GC'ing of valid data when moved from online to offline state. That is, while in archival storage, the file is prevented from being modified/removed as other online snapshots may depend on that file.

In sum, the technique is directed to a rollback of a restored LKG snapshot, wherein all intervening snapshots (between the Live snapshot and LKG) are hidden from the user. Because a distributed share may be sharded within a group of shards (datasets) distributed among FSVMs and VGs, a corresponding group of snapshots may be atomically rolled back and undone as a single consistent transaction. That is, if one snapshot of one share on a VG fails, all snapshots of the share on all other VGs are rolled back to maintain consistency of the sharded distributed share. A benefit of the failure-safety requirement is that the technique provides restore atomicity for a distributed share (i.e., across all virtual dataset entities). As noted, the two phases of the atomic transaction are restore and commit.

Another aspect of the technique is that during the restore phase and prior to committing, an administrator can inspect the content of a snapshot that requires restoration. There may be content, e.g., one or more files, of the Live snapshot that is good (e.g., uncorrupted) and should be retained. The good content may be copied to one or more datasets (files/folders) of the share to minimize data loss when transitioning back to a previous LKG snapshot state. This aspect of the technique allows making use of handpicking (i.e., selecting) data in a snapshot that is copied, e.g., by an administrator. The out-of-place restore operation may be leveraged to invoke such handpicking and copying of good content from, e.g., a corrupt current (Live) snapshot, to a restored LKG (S2) snapshot prior to committing at the commit phase. Illustratively, the CFT feature may be used without tiering to identify files that have been added, changed, or deleted across the Live and S2 snapshots. Note that since the restore operation is a disruptive operation, I/O workload operations are paused or quiesced (halted) until the restore is committed. If not committed, e.g., because of data corruption in the share, the technique may rollback to another (i.e., uncorrupted) LKG share (snapshot). Note also that this includes undoing of a snapshot restore operation for a distributed share (an administrative operation) wherein the distributed share includes a group of snapshot datasets (shards). That is, the technique includes the capability to restore a distributed share and undo a distributed share restore. When the shards of the distributed share are distributed on different VGs (nodes) and one of the VGs (nodes) fails, the technique restores the distributed share to a LKG share. If it is determined, e.g., that the LKG share is corrupted, the technique enables undo of the share restore by automatic rollback to the last LKG share using intermediate clones and snapshots.

In addition, the out-of-place restore includes a sequence of filesystem steps on the filesystem datasets (shards): rename of original filesystem datasets; cloning of the LKG snapshot to create new cloned filesystem datasets and forking off to the cloned share dataset; and promote the new cloned filesystem datasets to reverse the parent-child relationship to the old LKG snapshot and original datasets. Thereafter, a potential corruption to the new cloned dataset may be uncovered (detected), which leads to a rollback and restore (and, if necessary, undo) as described herein.

Further, the distributed share restore capability of the technique enables storing of datasets (files/folders) on the object store with tiering enabled, which includes use of CFT to provide share restore optimally by allowing share data consistency on the remote tiered storage.

The foregoing description has been directed to specific embodiments. It will be apparent, however, that other variations and modifications may be made to the described embodiments, with the attainment of some or all of their advantages. For instance, it is expressly contemplated that the components, logic, and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
restoring, at a computing node, a snapshot of an original filesystem dataset exported as a share to a client using an atomic transaction administratively applied by the client in two phases, wherein
a first phase includes (i) renaming the snapshot, (ii) creating a clone of the snapshot; and (iii) promoting the clone, wherein promotion of the clone decouples and reverses dependency between the renamed snapshot and the clone, and
a second phase includes, (i) deleting the original filesystem snapshot dataset;
determining whether the restored snapshot is corrupt prior to applying the second phase; and
in response to determining that the restored snapshot is corrupt, rolling back application of the first phase.

2. The method of claim 1, wherein the exported share is a distributed share having datasets as a group of shards distributed across a plurality of computing nodes, wherein the first phase is applied to each of the shards, and wherein corruption of the restored snapshot includes a failure to successfully apply the first phase to any of the shards.

3. The method of claim 2, wherein in response to the determination that the restored snapshot is corrupt, rolling back further includes rolling back application of the first phase for the datasets of each shard in the group.

4. The method of claim 2, wherein a portion of data of at least one shard is moved to an archival storage tier, wherein Change File Tracking (CFT) is used to track the archived data, and wherein the CFT is used to restore the archived data of the at least one shard to the computing node during the first phase.

5. The method of claim 1, wherein the snapshot is maintained to comply with recovery point objectives.

6. The method of claim 1 wherein after the first phase, the client selects and copies data from the original filesystem to another dataset prior to the second phase.

7. The method of claim 1 wherein creating a clone of the snapshot further comprises cloning a last known good snapshot that is uncorrupted.

8. A non-transitory computer readable medium including program instructions for execution on a processor of a computing node, the program instructions configured to:
restore a snapshot of an original filesystem dataset exported as a share to a client using an atomic transaction administratively applied by the client in two phases, wherein
a first phase includes (i) rename the snapshot, (ii) create a clone of the snapshot; and (iii) promote the clone, wherein promotion of the clone decouples and reverses dependency between the renamed snapshot and the clone, and
a second phase includes, (i) delete the original filesystem snapshot dataset;
determine whether the restored snapshot is corrupt prior to applying the second phase; and
in response to determining that the restored snapshot is corrupt, roll back application of the first phase.

9. The non-transitory computer readable medium of claim 8 wherein the exported share is a distributed share having datasets as a group of shards distributed across a plurality of computing nodes, wherein the first phase is applied to each of the shards, and wherein corruption of the restored snapshot includes a failure to successfully apply the first phase to any of the shards.

10. The non-transitory computer readable medium of claim 9 wherein in response to the determination that the restored snapshot is corrupt, the program instructions configured to roll back further include program instructions configured to roll back application of the first phase for the datasets of each shard in the group.

11. The non-transitory computer readable medium of claim 9 wherein a portion of data of at least one shard is moved to an archival storage tier, wherein Change File Tracking (CFT) is used to track the archived data, and wherein the CFT is used to restore the archived data of the at least one shard to the computing node during the first phase.

12. The non-transitory computer readable medium of claim 8 wherein the snapshot is maintained to comply with recovery point objectives.

13. The non-transitory computer readable medium of claim 8 wherein after the first phase, the client selects and copies data from the original filesystem to another dataset prior to the second phase.

14. The non-transitory computer readable medium of claim 8 wherein the program instructions configured to create a clone of the snapshot are further configured to clone a last known good snapshot that is uncorrupted.

15. An apparatus comprising:
a computing node having a processor configured to execute program instructions to,
restore a snapshot of an original filesystem dataset exported as a share to a client using an atomic transaction administratively applied by the client in two phases, wherein
a first phase includes (i) rename the snapshot, (ii) create a clone of the snapshot; and (iii) promote the clone, wherein promotion of the clone decouples and reverses dependency between the renamed snapshot and the clone, and
a second phase includes, (i) delete the original filesystem snapshot dataset;
determine whether the restored snapshot is corrupt prior to applying the second phase; and
in response to determining that the restored snapshot is corrupt, roll back application of the first phase.

16. The apparatus of claim 15 wherein the exported share is a distributed share having datasets as a group of shards distributed across a plurality of computing nodes, wherein the first phase is applied to each of the shards, and wherein corruption of the restored snapshot includes a failure to successfully apply the first phase to any of the shards.

17. The apparatus of claim 16 wherein in response to the determination that the restored snapshot is corrupt, the program instructions to roll back further include program instructions to roll back application of the first phase for the datasets of each shard in the group.

18. The apparatus of claim 16 wherein a portion of data of at least one shard is moved to an archival storage tier, wherein Change File Tracking (CFT) is used to track the archived data, and wherein the CFT is used to restore the archived data of the at least one shard to the computing node during the first phase.

19. The apparatus of claim 15 wherein the snapshot is maintained to comply with recovery point objectives.

20. The apparatus of claim 15 wherein after the first phase, the client selects and copies data from the original filesystem to another dataset prior to the second phase.

21. The apparatus of claim 15 wherein the program instructions to create a clone of the snapshot further include program instructions to clone a last known good snapshot that is uncorrupted.
